(19) United States
(12) Patent Application Publication
(10) Pub. No.: US 2015/0220631 A1
(43) Pub. Date: Aug. 6, 2015

(54) CONTENT REPOSITORY AND RETRIEVAL SYSTEM

(71) Applicant: Dale SHERMAN, (US)

(72) Inventor: Dale S. Sherman, Los Angeles, CA (US)

(21) Appl. No.: 14/410,780

(22) PCT Filed: May 23, 2013
(86) PCT No.: PCT/US2013/042445

§ 371 Date: Dec. 23, 2014

Related U.S. Application Data
(60) Provisional application No. 61/650,829, filed on May 23, 2012.

(51) Int. Cl. G06F 17/30

(52) U.S. Cl. CPC G06F 17/30734; G06F 17/30675; G06F 17/30011

(57) ABSTRACT

The invention for data storage and retrieval of non-structured data is provided. The invention gives the user the ability to upload, store, and retrieve any file through a simple interface with the capacity of storing any one of a number of media types. Moreover, while it has the capability of storing information based on traditional field types such author, year, and title, the invention greatly expands a user's ability to store and compile multiple subject and keyword attributes making it a much more functional personal library knowledge base through, in an embodiment, construct mining, a method of concept extraction.

### RELATED APPLICATIONS

This application is a non-provisional application and which claims priority of U.S. Provisional Application No. 61/680,477, entitled Content Repository and Retrieval System, filed on May 23, 2012, the disclosure of which is hereby incorporated by reference in its entirety.

### BACKGROUND

1) Field of the Invention

The invention relates to content management. More particularly, a content management and retrieval system.

2) Discussion of the Related Art

It has been estimated that as high as 80% of all knowledge is stored as non-structured data in text form; data represented as written documentation in text format. The volume of information contained in published documents, journal articles, emails, etc. is growing at an exponential rate particularly with the rapid growth in the World Wide Web, and more recently, The Cloud. As a result, the ability to store and search non-structured data for target information has become crucial to managing the volume of growing information. There is an ever increasing demand to store, locate and extract concepts and ideas within non-structured data. Moreover, searching for ideas within text is the primary, underlying goal of most, if not all, document searches. While the user may enter keywords or terms to search, he or she is really looking for an idea, or construct, which the terms represent and the user wishes to find in a document.

Moreover, users do not have an efficient means to retain information in a knowledge base for easy access. Word processing files, spreadsheets, or files in pdf format may be stored on hard drive, CD/DVD media or other portable USB storage device, yet there is no way to cross reference these items or retrieve them in conjunction with other searches. Storage and retrieval of items may fail or the item may be misplaced, moved, or altered losing the file's original defining properties. In addition, while the name of the file or other file attribute may reflect part of the item's purpose or function, there is no means to assign additional meaning to the file, expand the references' topic coverage (areas of relevance) or enhance the file's attributes.

Finally, there are few ways to retrieve an item without knowing the exact name of the file or being fairly certain of it. There is little capacity to enter and do a search on a small portion of what might be in the title or name. However, users frequently recall only a small portion of an item and forget significant portions about what they wish to retrieve.

Other areas missing in existing inventions include the ability to assign the type of file, which is being stored a key aspect of a document's character. For instance, while word processing or pdf files are comprised of text, it is the text which dictates the nature of the file. Users have limited means to designate the type of the document the file represents such as case study, research article, conference paper, review article, brief, report, etc. By giving users the ability to assign this additional parameter, items may be grouped with related items (i.e. report or research article) and searched with greater efficiency. Below are several embodiments of the invention.

### BRIEF DESCRPTION OF THE DRAWINGS

FIG. 1 is a flowchart or schema illustrating document upload, construct extraction & file storage feature

FIG. 2 a flowchart or schema illustrating search feature

FIG. 3 a flowchart or schema illustrating search example: construct

FIG. 4 is a flowchart or schema illustrating a search example: cross-content

FIG. 5 is flowchart or schema illustrating a search example: demographics

FIG. 6 illustrates cross store search (user 1+user 2 . . . user n)

FIG. 7 illustrates term-link/embed references

FIG. 8 illustrates a knowledge base search user entry & auto-populate

FIG. 9 illustrates knowledge base search—software driven search

FIG. 10 illustrates search results returned findings list of available files

FIG. 11 illustrates search results select desired findings to retrieve file

FIG. 12 illustrates display contents of a file

FIG. 13 illustrates display profile of a file/reference in the knowledgebase

FIG. 14 illustrates list all references

FIG. 15 illustrates list by subject

FIG. 16 illustrates display search result by subject

FIG. 17 illustrates a list by keyword

FIG. 18 illustrates a list by document type

FIG. 19 illustrates add reference (user based)

FIG. 20 illustrates add reference—subject/keyword selection (user based)

FIG. 21 illustrates add reference—document type (user based)

FIG. 22 illustrates file upload

FIG. 23 illustrates edit a reference

FIG. 24 illustrates ontology: subject+keyword

FIG. 25 illustrates view/edit subjects

FIG. 26 illustrates add subject/keyword

FIG. 27 illustrates document types

FIG. 28 illustrates add/edit document type

### DETAILED DESCRIPTION OF THE INVENTION

The present invention, in an embodiment, is designed to optimize both the storage and search process through construct mining, the underlying purpose of text mining. Construct mining is defined as the process of extracting keywords contained in the text and assimilating those terms into representative core ideas or concepts reflected by the document. By automatically extracting constructs and keywords or by allowing the user to define the subject & keyword of an item, the user can optimize subsequent searches; increase possible cross-references and drill down searches in the knowledge base with greater capacity and accuracy. This further allows for storing articles in a data warehouse with greater detail, such that there is a greater likelihood the user will be able to search and retrieve the item successfully.

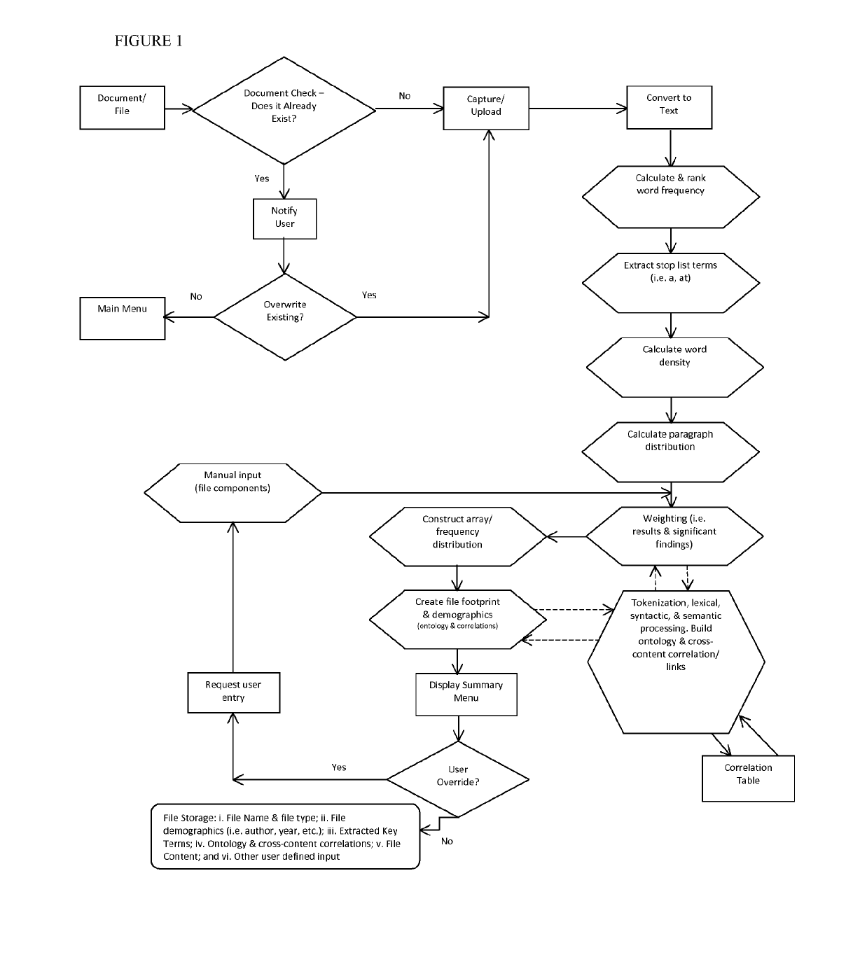

The invention is designed as a knowledge base for easy data storage and retrieval of non-structured data. It gives the user the ability to upload, store, and retrieve any file through a simple interface with the capacity of storing any one of a number of media types including word processing, text files, pdf, spreadsheets, video, audio, or power point presentations. Moreover, while it has the capability of storing information based on traditional field types such author, year, and title, this invention greatly expands the user's ability to store and compile multiple subject and keyword attributes making it a much more functional personal library knowledge base. A key function of the invention is to perform construct mining, a method of concept extraction. Please see FIG. 1 for a flowchart of the processes associated with the invention including file upload, construct extraction and file storage in the database.

Construct mining is defined as the process of extracting keywords contained in the text and assimilating those terms into representative core ideas or concepts reflected by the document. Several elements of the method and system described herein include conventional, well-known elements that need not be explained in detail here. For example, client system might include a desktop personal computer, workstation, laptop, PDA, cell phone, any wireless application protocol (WAP) enabled device or any other computing device capable of interfacing directly or indirectly to the Internet. The client system typically runs a browsing program, such as Microsoft's Internet Explorer™ browser, Netscape Navigator™ browser, Mozilla™ browser, Opera™ browser, a WAP-enabled browser in the case of a cell phone, a PDA or other wireless device, allowing a user of client system to access, process and view content available to it from a server system over network.

The client system might also include one or more user interface devices, such as a keyboard, a mouse, a roller ball, a touch screen, a pen or the like, for interacting with a graphical user interface (GUI) provided by the browser on a display (e.g., monitor screen, LCD display, etc.), in conjunction with pages, forms and other information provided by the server system or other servers. The present invention is suitable for use with the Internet, which refers to a specific global internetwork of networks. However, it should be understood that other networks can be used instead of or in addition to the Internet, such as an intranet, an extranet, a virtual private network (VPN), a non-TCP/IP based network, any LAN or WAN or the like.

According to an embodiment, client system and system servers and their respective components are operator configurable using an application including computer code run using one or more central processing units, such as those manufactured by Intel, AMD or the like. Computer code for operating and configuring client system to communicate, process and display content as described herein is preferably downloaded and stored on a hard disk, but the entire program code, or portions thereof, may also be stored on any other volatile or non-volatile memory medium or device as is well known, such as a ROM or RAM, or provided on any media capable of storing program code, such as a compact disk (CD) medium, a digital versatile disk (DVD) medium, a floppy disk, and the like. Additionally, the entire program code, or portions thereof, may be transmitted and downloaded from a software source, e.g., from one of server systems to client system over network using a communication medium and protocols (e.g., TCP/IP, HTTP, HTTPS, Ethernet, or other conventional media and protocols). As referred to herein, a server system may include a single server computer or number of server computers.

Construct Mining & Extraction Keyword Assignment

The purpose of written documentation is to house ideas and reflect concepts in text format. Non-structured data is, by definition, data in text format. There is an ever-increasing demand for better methods to identify and locate the ideas and concepts contained within text forms of documentation. This invention is designed to meet that need by extracting core pieces of information from the document through construct mining and store it for ease of retrieval at a later time. As indicated above, construct mining is defined as the process of extracting keywords contained in text and assimilating those terms into representative core ideas or concepts reflected by the document. This is accomplished through identifying the word frequency, word density, and paragraph distribution (Please see FIG. 1). This may be outlined more thoroughly by the following process;

A. Word Frequency

The frequency of single words contained in the document is extracted and rank ordered in a distribution list. This excludes stop list words such as of, a, an, and other grammatical punctuations.

B. Word Density

Words, which fall in close proximity to each other, have higher relational meaning and greater potential of representative value. In this second step, terms identified in the word frequency search are examined as potential word pairs and rank ordered in a separate process. Co-occurrence of terms has been thought to have higher representational meaning and used quite frequently in text mining.

C. Paragraph Distribution

As words which fall in close proximity to each other has greater potential relational meaning, words with higher paragraph distribution throughout the document are also likely to have greater significance. In this third step, terms identified in the word frequency search are examined as potential core paragraph ideas and listed in a separate process.

D. Construct Array

To determine the core ideas of a document as a representative construct, the terms identified by the above processes, (i) word frequency, (ii) word density, and (iii) paragraph distribution, are plotted as a 3-dimensional array. The terms which have a greater degree of frequency have a higher value, calculated as the degree of co-occurrence or an index of bias (i.e. chi-squared), and are weighted more heavily. Those terms are then selected as being more representative of the document and returned as key terms.

E. Ontology & Correlation

The extracted terms may also be compared and added to both an ontology table and cross-content correlation table in the database. The ontology table is designed to create a representative list of terms and keywords from documents in the knowledgebase. The cross-content/correlation table is designed to house terms which have a higher degree of association which may be of interest to the user in searches or other contexts. For instance, the user may wish to perform a search and locate all documents related to cognitive aspects of depression (i.e. memory & problem solving). See relational cross-content search below.

F. Storage

These key terms are then stored with the document as keywords constructs enabling more rapid search and return of desired documentation.

G. Match

The term(s) entered by the user in a search may then be used as a selection comparison.

User Defined Subject/Keyword

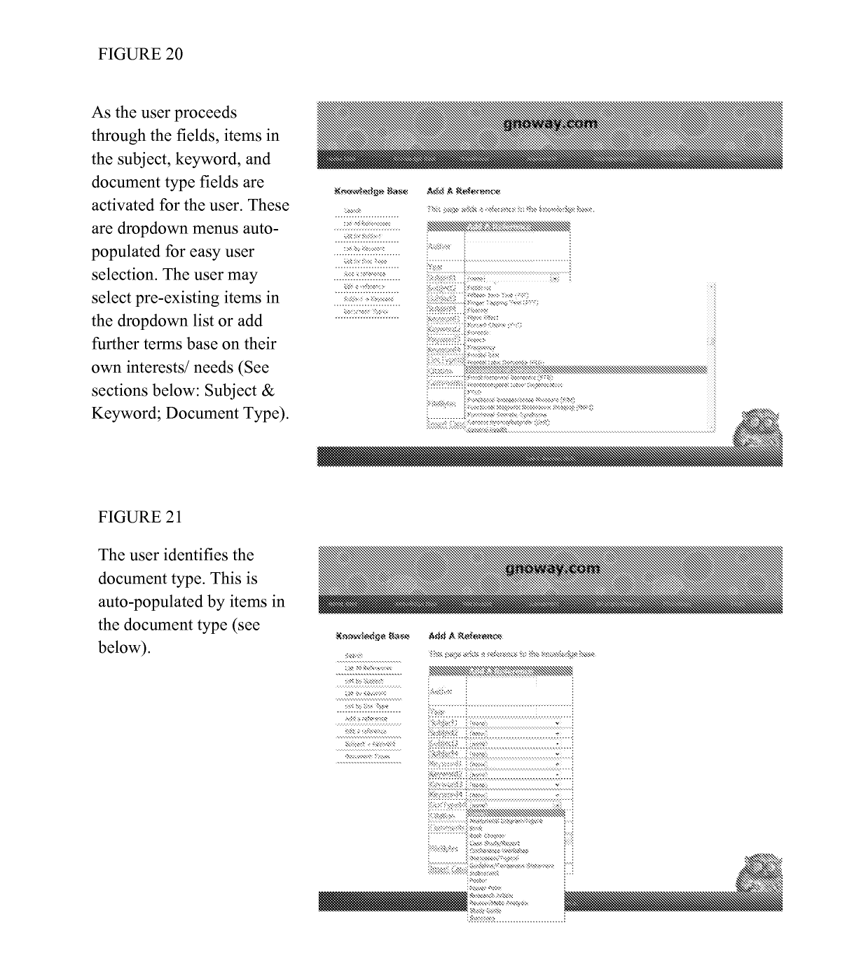

The user may also, if preferred, override automated construct mining and extraction to assign his/her own desired terms and subjects. Please see FIG. 20 for user based subject/keyword selection and assignment.

Content Definition

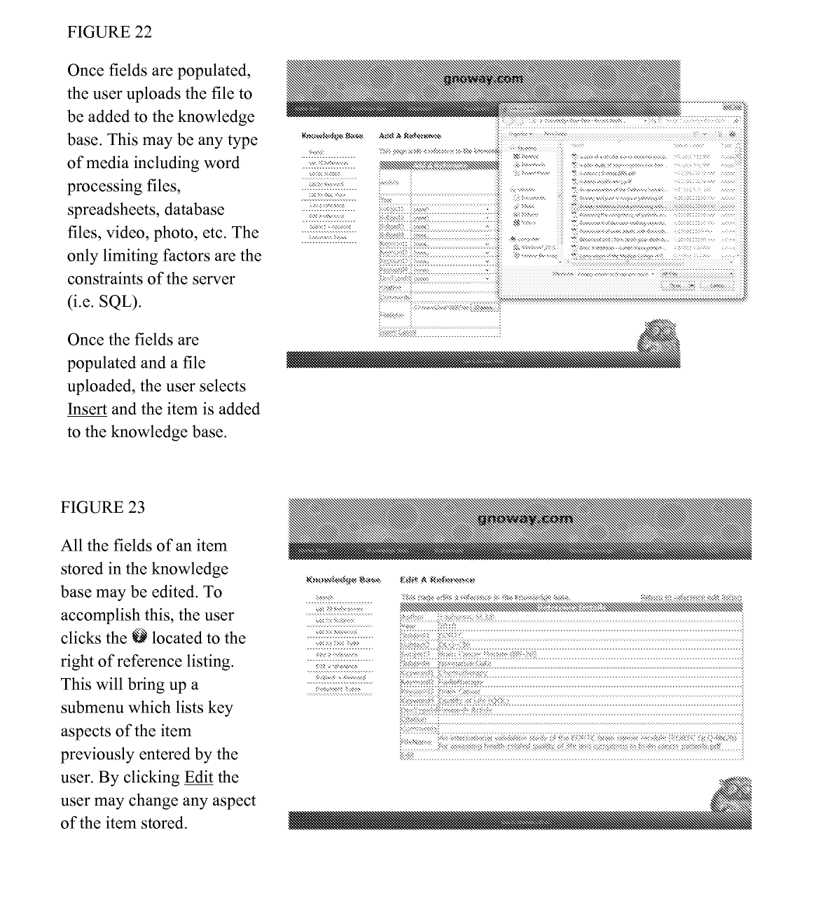

Unlike other database storage programs, the user is able to specifically designate the subject type of the material being stored. Items stored in the knowledge base may be assigned any number of subjects from the invention. This may range from a general topic (i.e. health) to very specific subject types (i.e. whole-brain radiation). By giving the user the ability to assign the subject type of the items being stored, the user's ability to drill down into the knowledge base in subsequent searches is greatly expanded. An illustration of user-driven process for adding a specific document is demonstrated in FIG. 19 with subject assignment in FIG. 20, document designation in FIG. 21, and upload of the specific item/file in FIG. 22.

Multiple Definitions

Generally, a single file will contain multiple content areas or may be associated with multiple domains of knowledge. A distinctive feature of this invention is the capacity to assign multiple, unique subject/keyword definitions (8+) to each file/item in the knowledge set. This greatly increases the user's search capacity and better represents the range of subject topics which any given document may cover. For instance, an article on memory may also include other key content areas including short-term memory, long-term memory, specific measures used to assess memory (i.e. Wechsler Memory Scale), if normative data was recorded in the item, role in dementia, forensic applications, and/or malingering. This is particularly essential for text or pdf files which may be quite dense in information and span several domains of knowledge.

Cross-Referenced Links

Assigning subject and keyword definitions to items in the knowledge set allows material to be linked and cross-referenced with other items which otherwise might be missed in a search. For instance, a search with conventional software on a topic such as memory would only bring up items with memory in the title or 1-2 other fields. However, when giving an item multiple definitions & keywords, this greatly increases the range of topics associated with a file and number of methods a file can be identified. For instance, a user entering the search term ‘Memory’, would also uncover items related to cortisol, post-traumatic amnesia, effects of radiation, and emotion (anxiety, depression), a substantially expanded result set.

Expandable Content Definitions

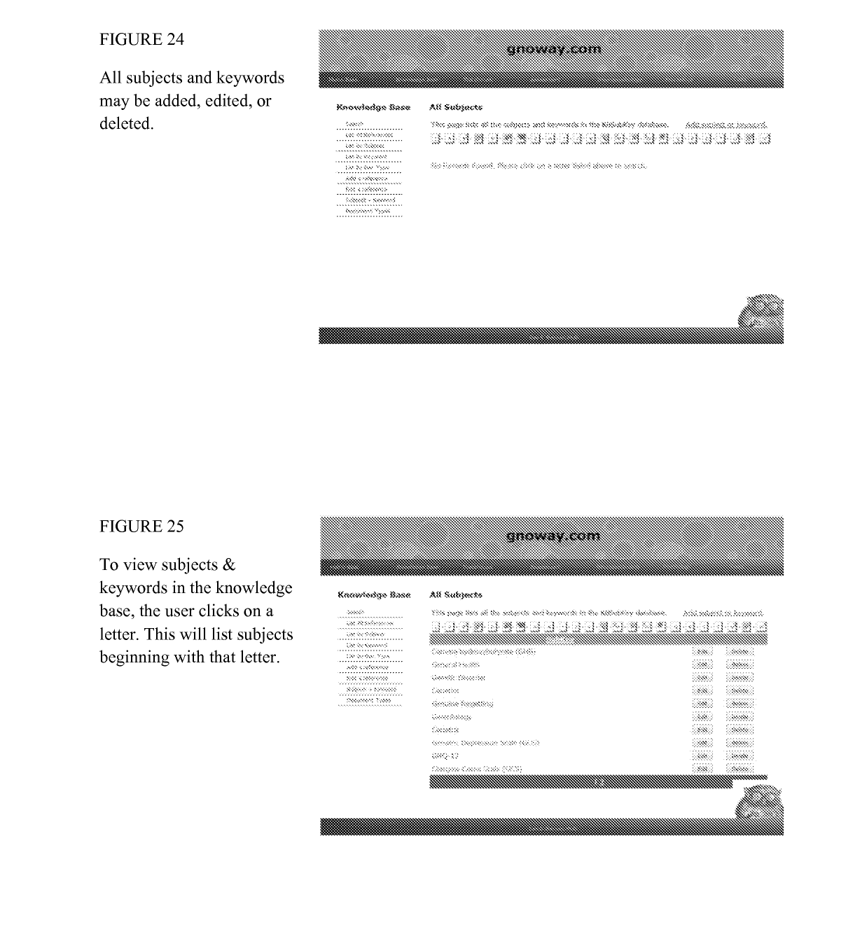

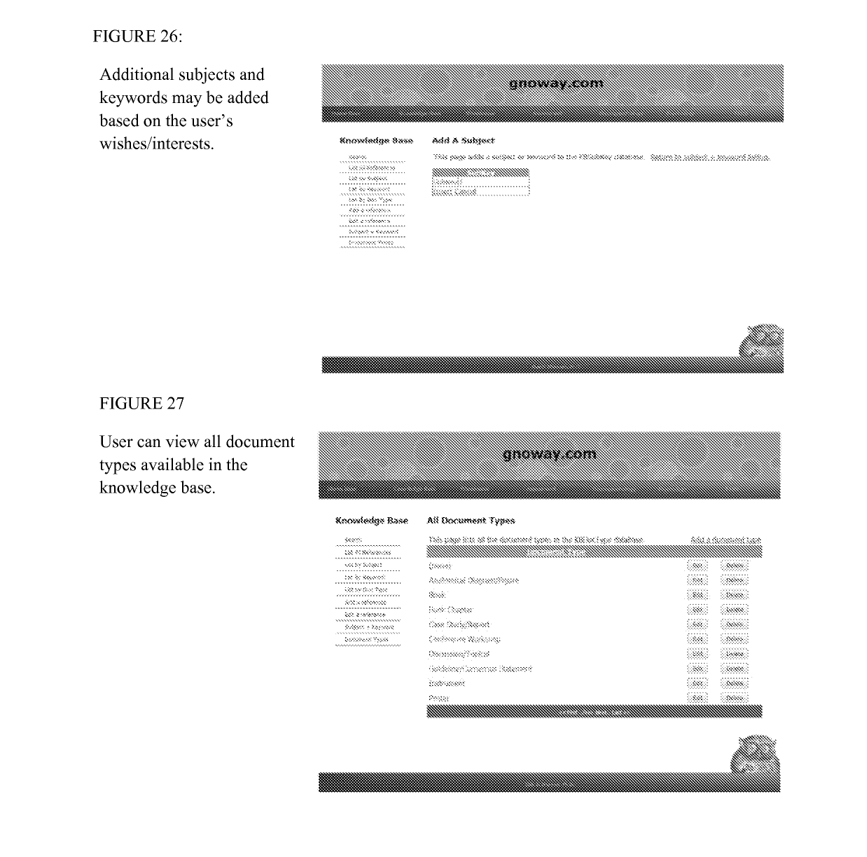

The number of subject/keyword may easily be expanded. The user may assign subjects & keywords from selections existing within the invention or he/she may add other content definitions. While the invention has a fair number of pre-loaded subject titles, he/she can add an indefinite number of additional subjects for his/her specific application(s) limited only by the limits of the database hardware/storage space. FIG. 24 displays the user interface to access the subject/keyword feature and FIG. 25 displays the view/edit function the user may utilize to add or edit content. FIG. 26 shows a specific instance of the field available to add a subject.

User Defined Document-Type

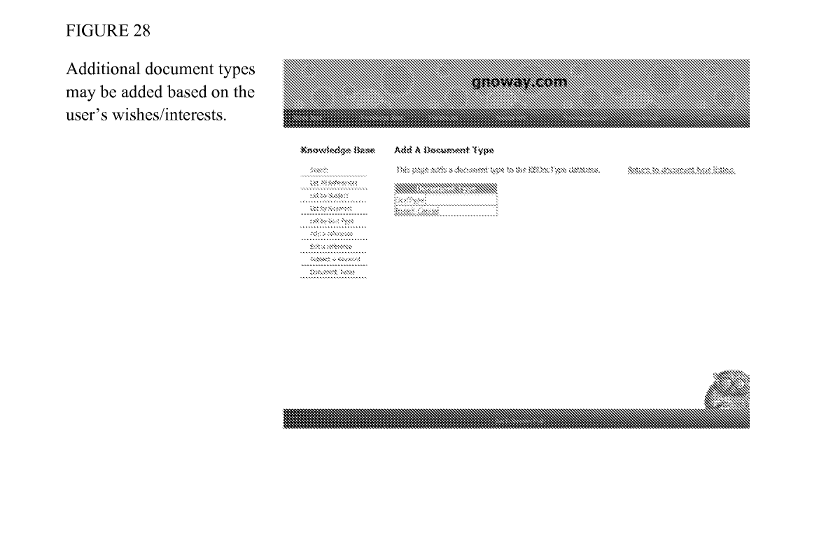

The user may also designate the type of document/item being stored. This gives the user an added dimension of the item as well as an additional method to search for items in the knowledge base. For instance, if the user wishes to view all items in the knowledge set which are a review or meta-analysis, he/she may select review/meta-analysis which will populate a list of items meeting that criteria. Similarly, if the user wishes to locate all items which are case studies, he/she may select case study. The range of document types include anatomical figure, book, book chapter, case study, case study, conference workshop, discussion, guideline, instrument, research article, study guide, or meta-analysis/review. For example, if the user wished to search articles which were a review or meta-analysis of memory, he/she would simply select review/meta-analysis in the drop-down menu which would then list all review articles. Please see FIG. 27 for an illustration of the user interface to access the document type feature and view/edit functions the user may utilize to add or edit content. FIG. 28 shows a specific instance of the field the user may access to add a subject.

User Interface

A. Browser Based Design

The user interface on the front-end is browser based. This allows for simple installation and future web based expandability.

B. Multiple Search Methods

Search-box.

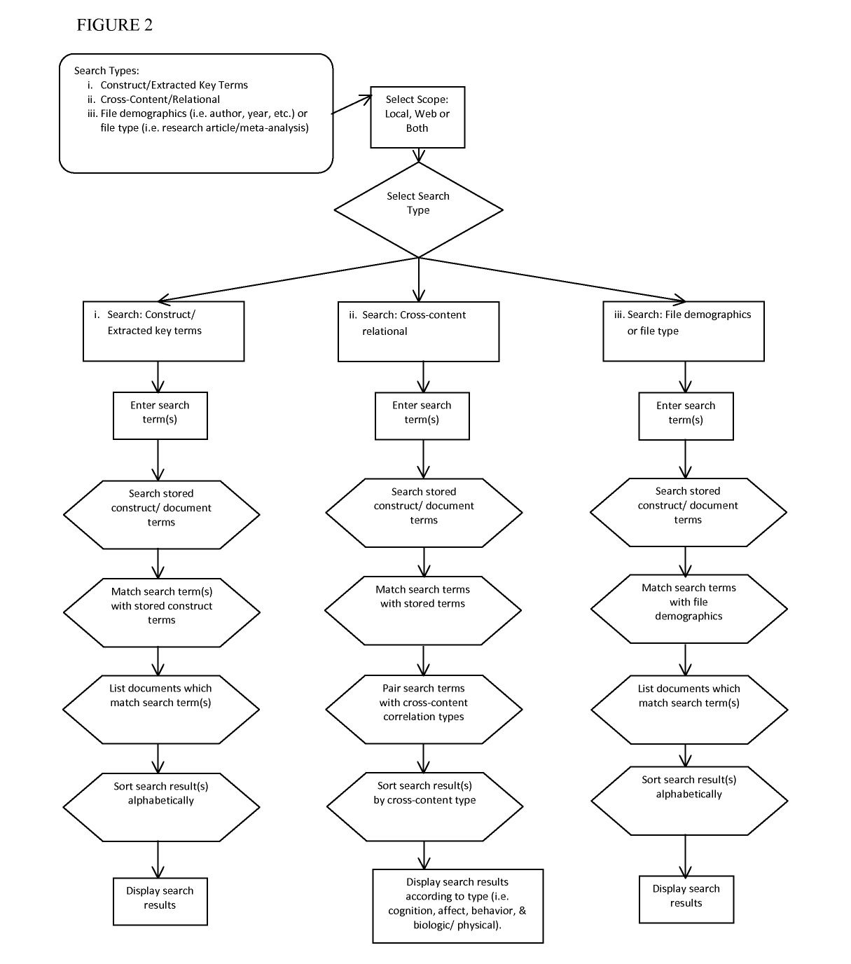

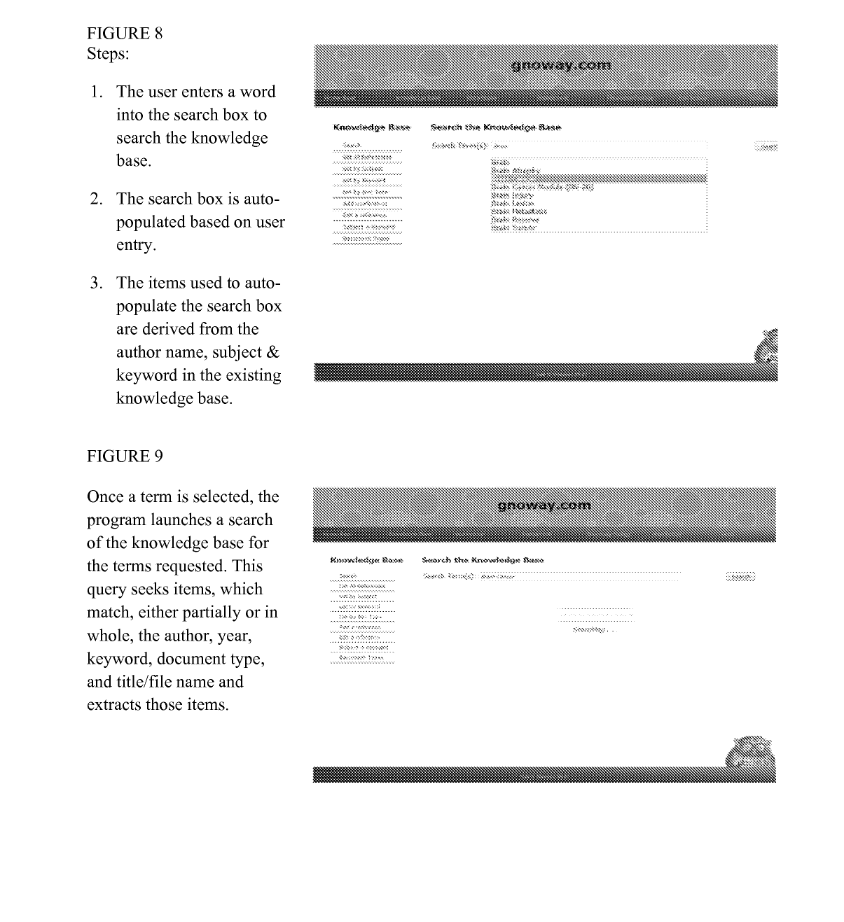

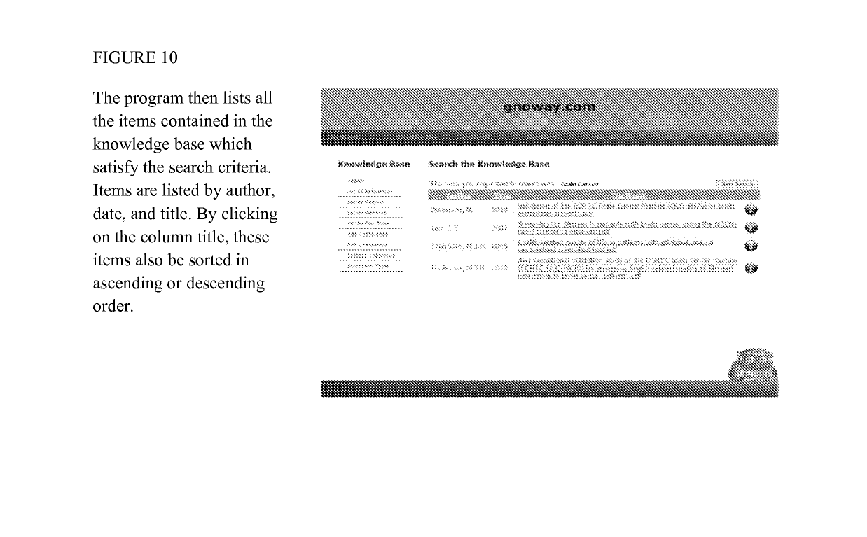

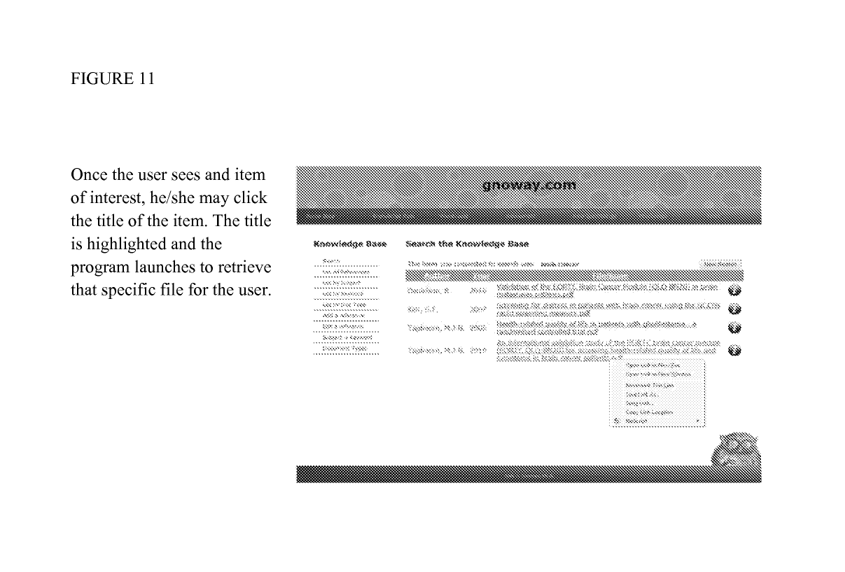

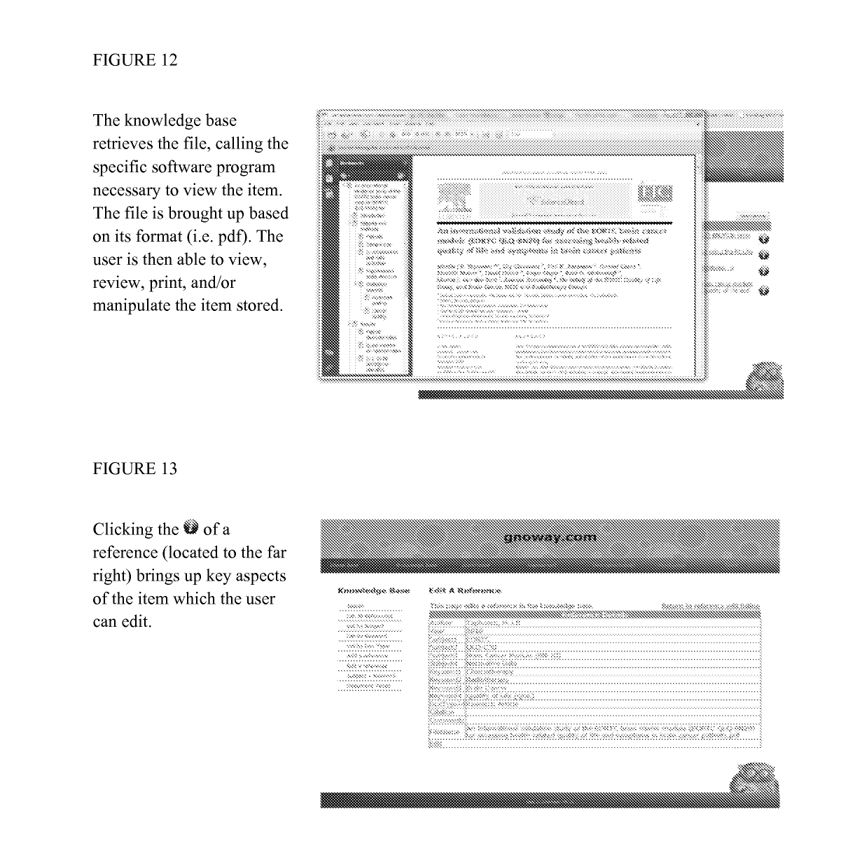

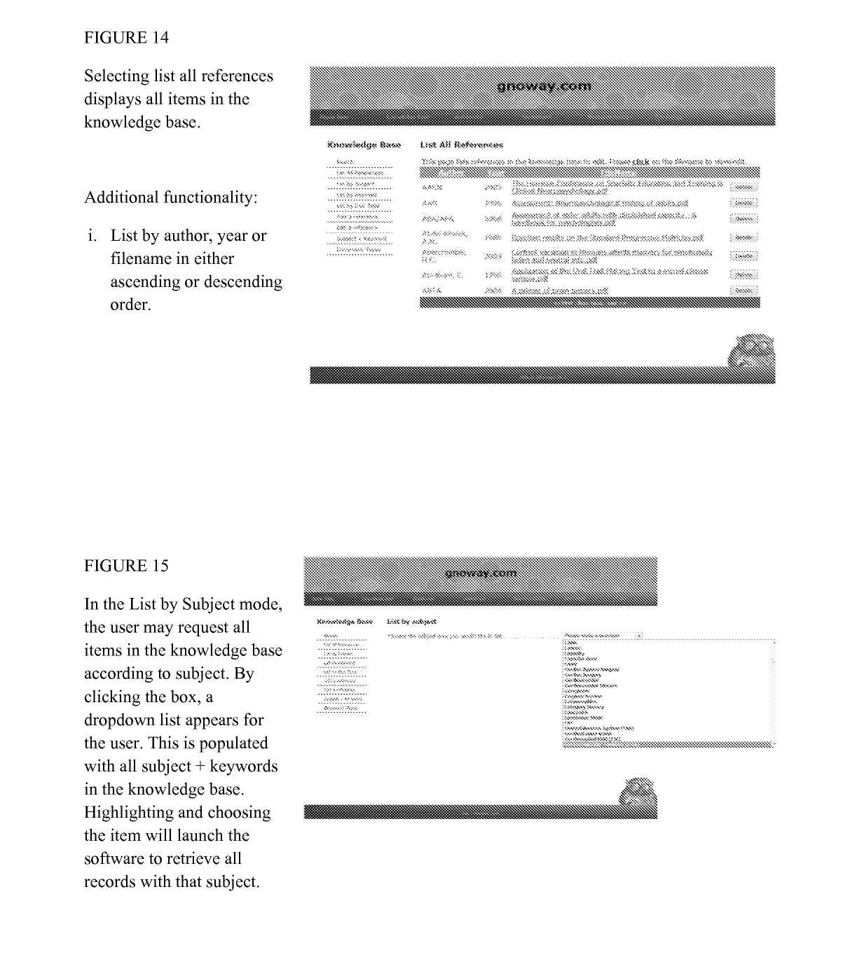

The user may search for any word, term, author, year, title, etc. in the knowledge base by entering that term in the search box. The invention will then search for and extract all items which match that search criteria. A flowchart of the search process for key terms, cross-content, and demographic information is outlined in FIG. 2. An example of the search box drop down is demonstrated in FIG. 8 with an ‘activated search’ demonstrated in FIG. 9. As indicated above, the invention then generates a list of items contained in the database (FIG. 10) and displays these with a link which, by clicking the link (FIG. 11), the stored contents of the time may be viewed directly (FIG. 13). A listing of all references may be generated for items in the database, as displayed in FIG. 14.

Subject/Keyword Search Drop-Down Menu:

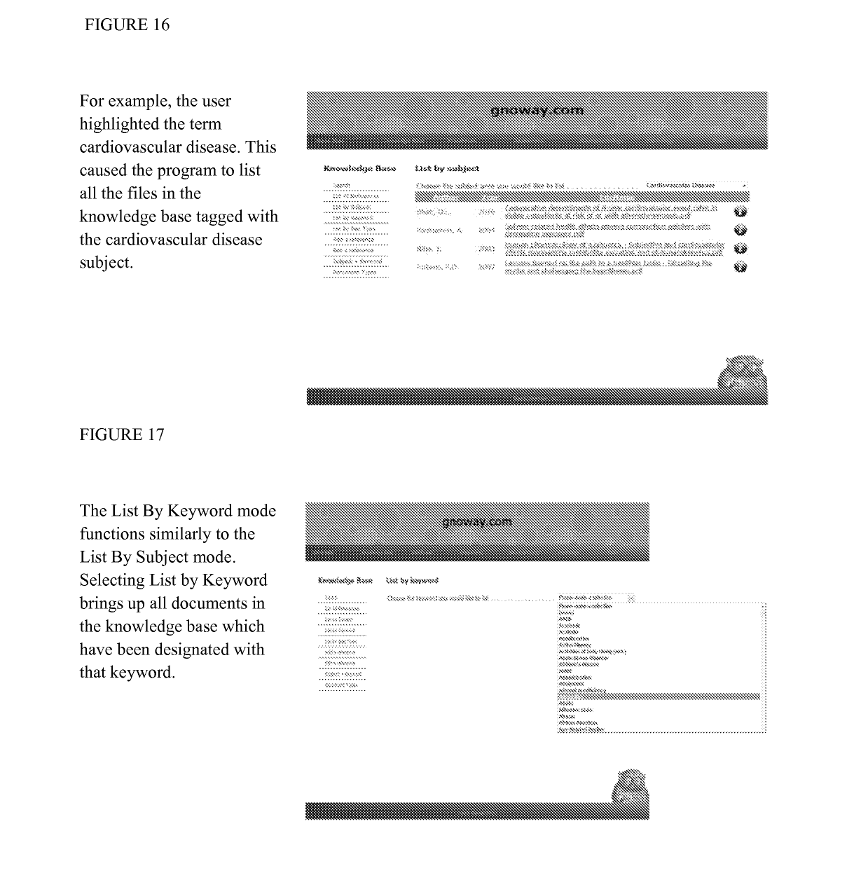

The user may select and search for any subject or keyword in the knowledge base. By selecting the subject/keyword from a drop-down list, the invention can search for and list all items in the knowledge base, which have that subject/keyword, associated with it. For instance, selecting the term memory will produce all items which have memory as one of its subject/keyword attributes. Please see FIGS. 15 and 17 for an example of subject & keyword searches and FIG. 16 for a display of search result-set of items contained in the database.

Document Type Search Drop-Down Menu:

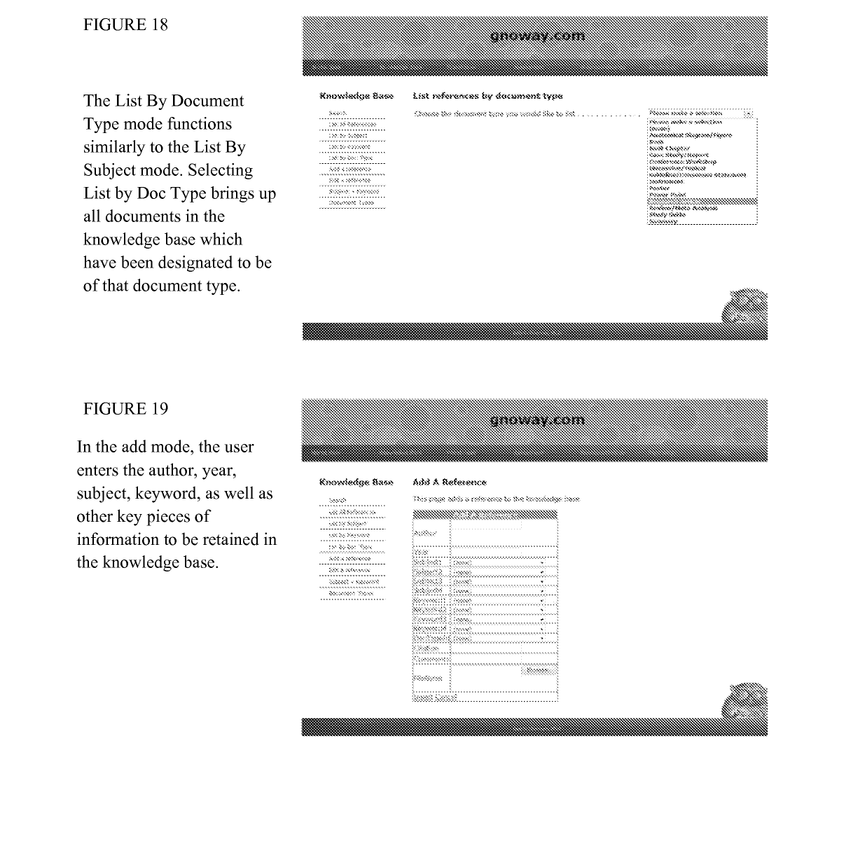

The user may also select and search for any document in the knowledge set based on document type (i.e. case study, research article etc.). By selecting document type from a dropdown list, the invention can search for and list all items in the knowledge base, which are that type of document. An example of a document-type drop-down menu search is presented in FIG. 18.

C. Flexibility to Edit or Alter Item Attributes

The user can edit or alter the attributes associated with a file any time after it has been stored in the knowledge base. FIG. 13 displays the profile of an item in the knowledgebase which the user can edit. FIG. 23 demonstrates specific fields and edit functions the user may access for each item contained in the database.

Search Algorithms

A. Construct Mining

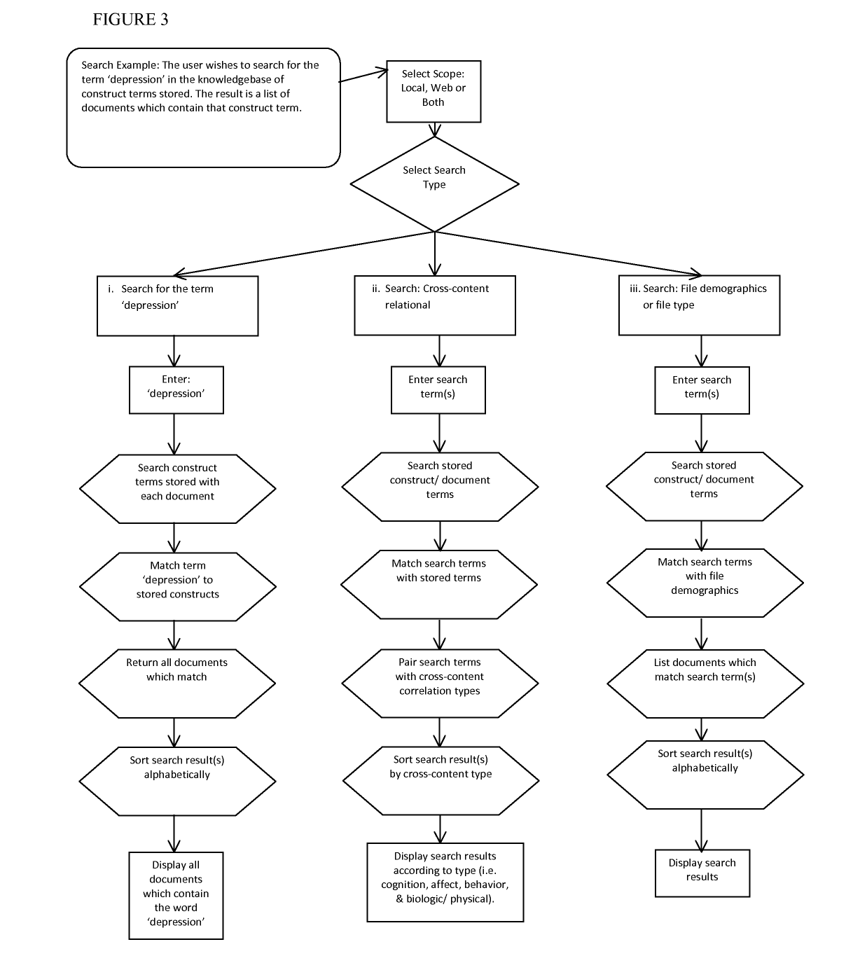

As indicated by the processes above, the constructs contained in the text are extracted and assigned to the document in the knowledge base for easy retrieval. The process of extracting keywords and assimilating these into representative core ideas and concepts improves accuracy of search reflected by the document. The user simply enters the desired term in the search box and documents with those assigned keywords are returned. The invention matches the desired search term with the construct stored for each document and returns those documents that fit the match. FIG. 3 demonstrates the construct mining search feature of the invention.

B. Cross-Reference Suggest/Text Mining:

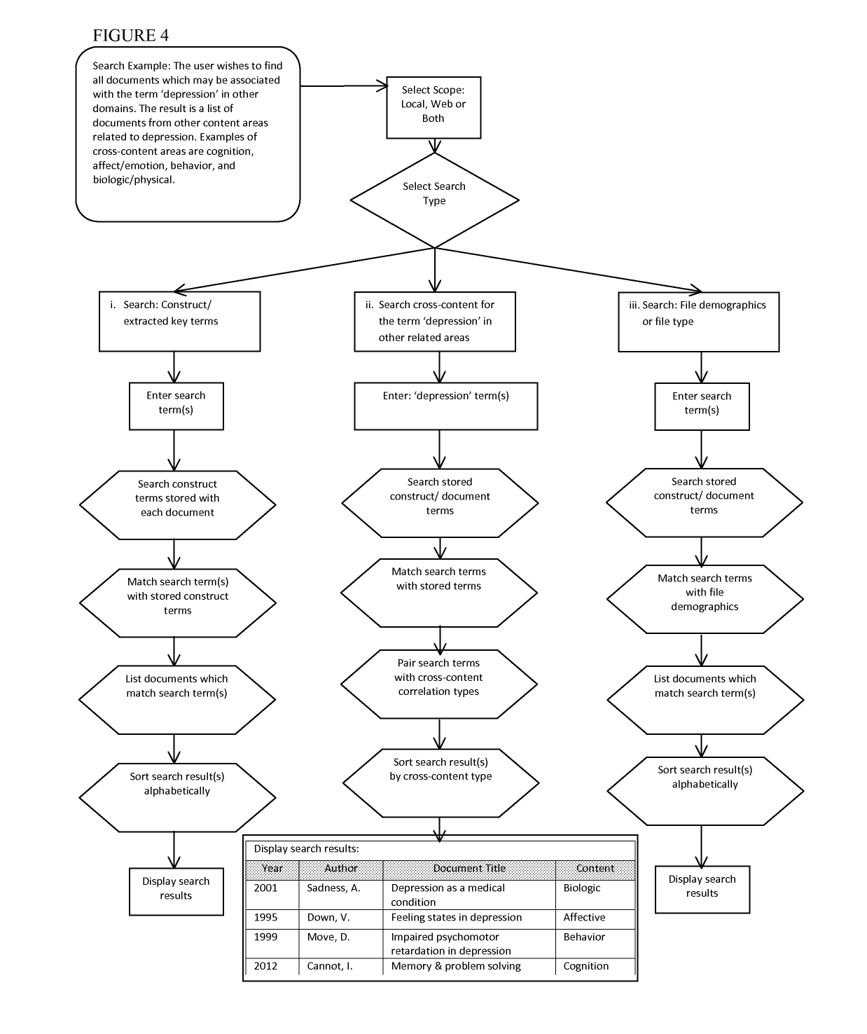

In many instances, the user may wish to find references or items in the knowledge base which may be related to his/her topic of interest but previously unknown to him/her. The invention includes a text mining search algorithm, which searches the knowledge base and returns a dataset of existing items rank ordered based on the degree of correlation between the target search and core terms of the reference. Please see FIG. 4 for a flowchart of the process associated with cross-content and cross-reference searches. Cross-reference text mining searches may be conducted in the following manner;

Relational Cross-Concept Format:

The invention extracts terms and core concepts from each reference which it then rank orders these into the top items/core concepts in an array. This is accomplished through tokenization, lexical, syntactic and semantic processing of the text contained in the document. The syntactic structure of phrasing and semantic use of language permits examination of the relationship between core concepts. This relational information is then reflected by the rank order and array.

Cognition-Affect-Behavior-Biologic:

The database contains a ‘correlational’ table which stores the strength of the relationship between aspects of the topic along other domains of knowledge or dimensions such as cognition, affect, behavior, and biologic. The user may select topic which returns a dataset of items rank ordered under each of the dimensions.

C. Broad Search Scope

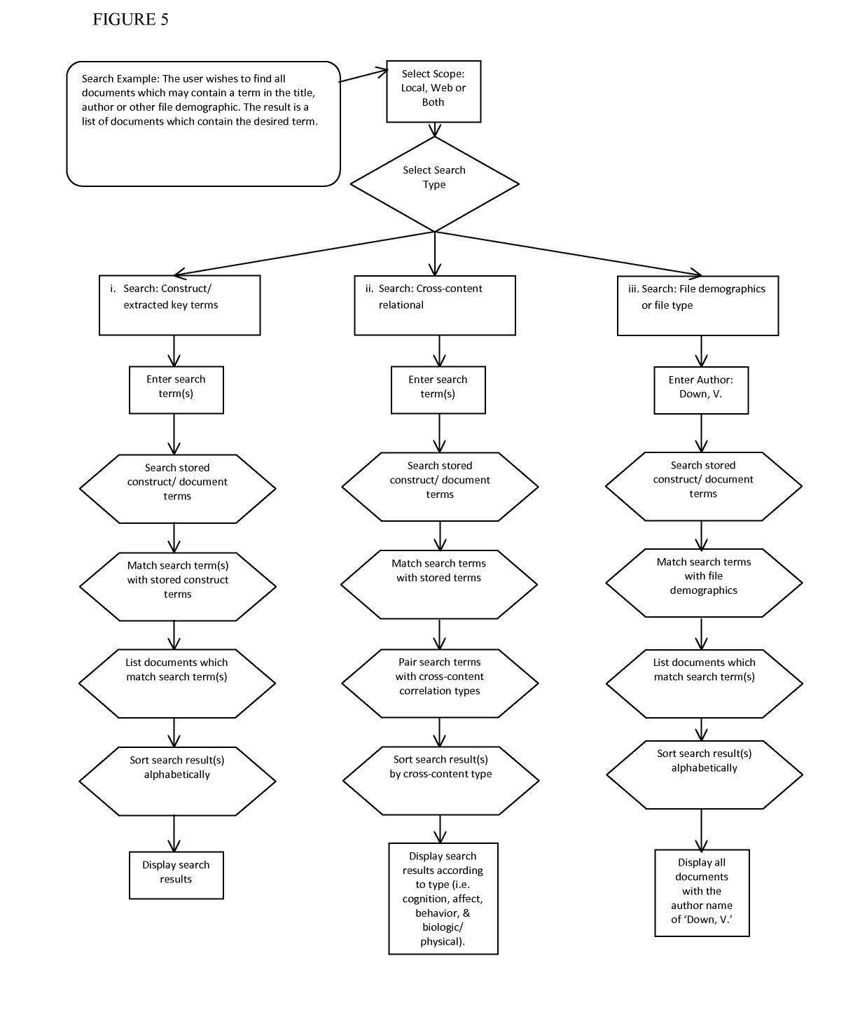

The code permits searches based on each key area the item is stored, author, year, keyword/subject, and/or title of the item. The user simply enters a general term of interest. Please see FIG. 8 for a general broad-based search and FIG. 5 for an example of a demographic-based search.

D. Specific:

Specific terms may be searched for by entering the key word/title desired. Please see FIG. 8 for an illustration of search box used to search specific terms.

Database Storage Media Types

The invention uploads items/files into the knowledge base through a simple user interface. The type of file uploaded into the knowledge base is only limited by the database storage engine and hardware capacity. The types of files which may be stored include word processing, pdf, video, spreadsheets, etc.

Storage Capacity

Limited only by the user's hardware storage capacity.

Term-Link

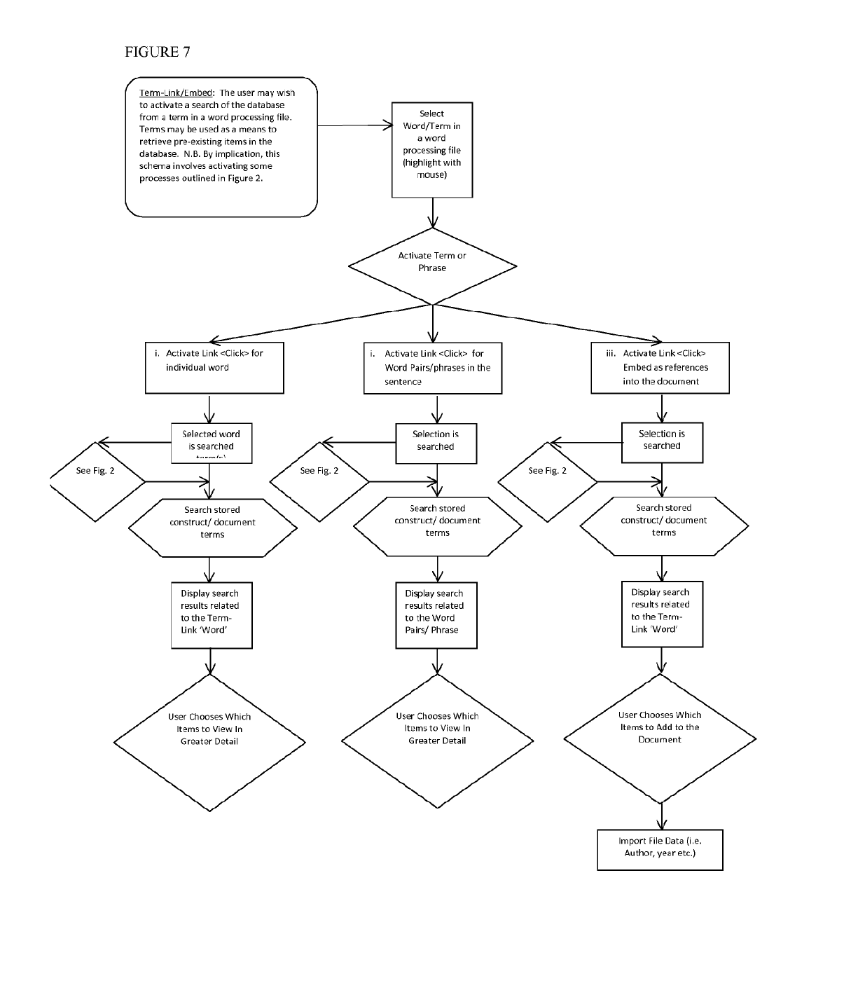

Key words and terms in the database ontology may be embedded into a document for quick retrieval of items in the database. For instance, the user may wish to retrieve items in the database related to a word ‘on demand’. This feature creates a link from the source document (i.e. word processing file) to the database which retrieves items when clicked. Sentence Example from a word processing document (i.e. MS Word): “Various types of memory have been related to anatomical structures in the hippocampus which, when disrupted in injury or disease, may alter retrieval of previously retained information.” In this example, the terms memory and hippocampus would activate the database to retrieve all related items when clicked by the user. Clicking these terms would activate the invention to retrieve the items and present them in a browser or window. The user would also have the option of importing the details of those references into the document (i.e. author, year, title, etc.) This feature allows the reader to have ‘ready’ access to items, display them as needed, and retrieve additional detail from the items retrieved. Please see FIG. 7 for a flowchart of this process.

Community Display

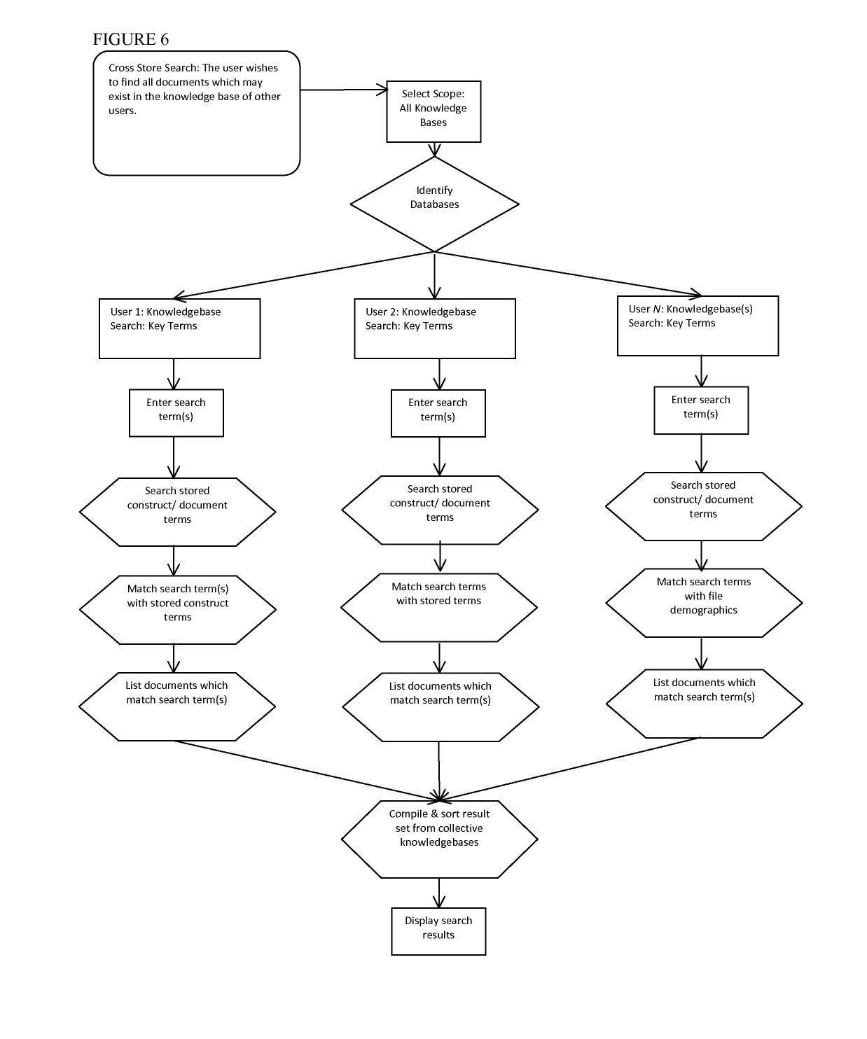

Database items are ‘community’ driven. The title, author, and select aspects of items uploaded into in the database (i.e. abstract) may be viewed by all users of the database. This is a unique feature in that all individuals with access to the database may view a portion of all other content stored in the database. This allows virtually limitless range of content items and source materials from many differing fields. Full content of individual items are restricted to individual users and not opened to others unless permissions are granted or permitted by the copyright holder. Please see FIG. 6 for a flowchart of this feature of the invention.

Outline of Program Operation.

1. Search: User defined search criteria. User enters a word they would like to search in the knowledge base. The user may also wish to identify documents with related or cross-content terms.

2. All References: All items in the knowledge base are listed and displayed for the user.

3. List by Subject: User selects subject or keyword then all items cross-referenced with that subject or keyword is selected and displayed for the user.

4. List by Keyword: Same as subject, except now a keyword is selected and displayed.

5. List by Document Type: User selects the document type then all items stored or cross-referenced with that document type is searched and displayed for the user.

6. Add a Reference: Interface, which allows the user to add and upload an item to the knowledge base.

7. Edit a Reference: Functionality that allows the user to alter all aspects of the item stored in the knowledge base.

8. Subject+Keyword: Add, modify, or delete any subject or keyword used.

9. Document Types: Add, modify, or delete any document time used in the knowledge base.

Although the foregoing invention has been described in some detail for purposes of clarity, it will be apparent that certain changes and modifications may be made without departing from the principles of the present invention. It should be noted that there are many alternative ways of implementing both the processes and apparatuses of the present invention. Accordingly, the present embodiments are to be considered as illustrative and not restrictive, and the invention is not to be limited to the specific details given herein.

Further, it will be understood that those skilled in the art, both now and in the future, may make various improvements and enhancements which fall within the scope of the claims which follow. These claims should be construed to maintain the proper protection for the invention first described.

What is claimed:

1. A system for content repository and retrieval, comprising:
a construction mining extraction module configured to define core attributes of non-structured data of at least one first content in providing at least one construct array;
a correlation and ontology module wherein said correlation ontology module correlates non-structured data of at least one first content and associates at least one content with at least one second content;
a user-defined module configured to receive information from a user to retrieve at least one of the at least one first and second content from the at least one database;
at least one database for storing the at least one first and second content; and
at least one server in communication with the at least one database for retrieving at least one of the at least one first and second content.

2. The system of claim 1 wherein the core attributes include at least one of word frequency, word density and paragraph distribution.

3. The system of claim 1 wherein the user-defined module is configured to receive subject type inputs from the user.

4. The system of claim 1 wherein the user-defined module is configured to receive a plurality of keyword subject definition inputs from the user.

5. The system of claim 1 wherein the correlation and ontology module generates an ontology table for the user.

6. The system of claim 1 wherein the correlation and ontology module generates a cross-content correlation table for the user.

7. The system of claim 6 wherein the correlation and ontology module rank orders according to at least one of tokenization, lexical, syntactic and semantic processing of the non-structured data.

8. The system of claim 1 wherein the user-defined module is configured an document type input from the user.

9. The system of claim 1 wherein the construction mining extraction module assigns the construct array to the at least one first content.

10. The system of claim 1 including a link module configured to embed a keyword link in the at least first content to the at least second content allowing the user retrieve related documents.
